(19) United States
(12) Patent Application Publication
(10) Pub. No.: US 2025/0269721 A1
(43) Pub. Date: Aug. 28, 2025

(54) Transfer case having a changeover clutch

(71) Applicant: Kleemann GmbH, Göppingen (DE)

(72) Inventors: Michael Gnam, Blaubeuren (DE); Ulrich Dörzbach, Heilbronn (DE)

(21) Appl. No.: 19/038,397

(22) Filed: Jan. 27, 2025

(30) Foreign Application Priority Data
Feb. 22, 2024 (DE) 10 2024 105 026.8

(51) Int. Cl. B60K 25/00; B02C 21/02; B60K 6/26; B60K 6/387; B60K 6/48; B60K 11/06; H02K 7/00; H02K 7/108; H02K 7/116

(52) U.S. Cl. CPC B60K 25/00; B02C 21/026; B60K 6/26; B60K 6/387; B60K 6/48; B60K 11/06; H02K 7/006; H02K 7/108; H02K 7/116; B60K 2025/005; B60Y 2200/92

(57) ABSTRACT

A drive for a mobile material processing plant includes an internal combustion engine and an electric motor. The internal combustion engine can be selectively coupled to or uncoupled from a mechanical drive train at its drive end by an internal-combustion-engine clutch and the electric motor can be selectively coupled to or uncoupled from the mechanical drive train by an electric-motor clutch. The drive train has an output end having at least one output, wherein at least one machine unit, in particular an electric generator, is driven by the output(s). The at least one machine unit may be coupled to or uncoupled from the output by a shiftable machine-unit clutch, and the electric-motor clutch or the internal-combustion-engine clutch may be operatively connected to the machine-unit clutch via a coupling, in particular a mechanical or hydraulic coupling.

### RELATED APPLICATIONS

The present application claims priority to German patent application Ser. No. DE 10 2024 105 026.8 filed Feb. 22, 2024, which is incorporated herein by reference.

### BACKGROUND OF THE DISCLOSURE

### Field of the Disclosure

The disclosure relates to a drive for a mobile material processing plant, in particular for a rock crusher, having an internal combustion engine and an electric motor, wherein the internal combustion engine can be selectively coupled to or uncoupled from a mechanical drive train at its drive end by means of an internal-combustion-engine clutch and the electric motor can be selectively coupled to or uncoupled from a mechanical drive train by means of an electric-motor clutch, wherein the drive train has an output end having at least one output, wherein at least one machine unit, in particular an electric generator, is driven by means of the output(s).

### Description of the Prior Art

In such material processing plants according to the disclosure, the electric motor and the internal combustion engine are preferably used to alternately drive the machine unit, in particular the crusher unit.

In the internal-combustion-engine mode, the internal combustion engine drives the mechanical drive train, and in the electric-motor mode, the electric motor drives the mechanical drive train with the interposition of a shiftable clutch (internal-combustion-engine clutch or electric-motor clutch). These clutches can function based on any of the common clutch principles. jaw, friction or form-fitting principle, in accordance with the Föttinger principle or any other hydraulic power transmission or combinations of the above-mentioned principles.

Preferably, the mechanical drive train also drives at least one hydraulic pump, which in turn drives one or more machine units.

Further preferably the mechanical drive train may drive, for instance, a crusher unit, a fan, an electric generator, a traction drive and/or a hydraulic drive, in particular a hydraulic motor or a hydraulic cylinder. For instance, hydraulic motors can also drive larger loads, such as drives for conveyor belts, chutes, etc. In very efficient drives, the mechanical drive train at an output also drives at least one electric generator (preferably as a replacement or in addition to at least one hydraulic pump), which supplies electrical energy for powerful auxiliary loads, such as electric motors, conveyor belts, chutes, screens, pump drives, etc. The use of electric drives for these auxiliary loads instead of hydraulic drives, significantly increases the machine efficiency.

U.S. Pat. No. 11,480,100 B2 discloses a material processing plant comprising a drive train for driving a crusher unit. Either an internal combustion engine can be coupled to the drive train via a free-wheel clutch or an electric motor can be coupled to a transmission of the drive train.

### SUMMARY OF THE DISCLOSURE

The disclosure addresses the problem of providing a drive of the type mentioned at the beginning, which permits an efficiency-optimized operation of the material processing system.

This problem is solved in that the at least one machine unit can be coupled to or uncoupled from the output by means of a shiftable machine-unit clutch, and in that the electric-motor clutch or the internal-combustion-engine clutch is operatively connected to this machine-unit clutch via a coupling, in particular a mechanical or hydraulic coupling.

According to the disclosure, the operation of the machine unit connected to the output via the machine-unit clutch is linked to the operation of the internal combustion engine or to the operation of the electric motor. This means that this specific machine unit, which is required either in the internal-combustion-engine mode or in the electric-motor mode, is actually only coupled to the drive train in this mode. In the mode in which it is not required, the machine unit is uncoupled and therefore does not need to be dragged along. This improves the efficiency of the overall system.

For instance, in the electric-motor mode, the electric motor clutch can be closed and the electric motor is thus connected to the drive train. The electric-motor clutch can now be connected via a coupling to a machine-unit clutch, in particular to a generator clutch, for instance. The generator clutch, in turn, is used to couple an electric generator to or uncouple it from the drive train. If the electrical generator is coupled to the drive train, it generates electricity for the electrical loads of the material processing device.

If the electric motor is coupled to the drive train in the electric-motor mode, it is supplied with electrical energy from a power supply, in particular from an external power supply. This electrical energy can also be used to supply the electrical loads with electricity. The electric generator is not required in this mode. It is thus indirectly uncoupled from the drive train via the active connection between the electric-motor clutch and the generator clutch.

However, if the material processing system is now operated in internal-combustion-engine mode, the electric motor clutch disconnects the electric motor from the drive train. As the electric-motor clutch is now operatively connected to the generator clutch, the electric generator can be coupled indirectly to the drive train by changing the shifting state of the electric motor clutch. The internal combustion engine drives the drive train and thus also the coupled electric generator. The latter can now produce electricity for the electrical loads as intended.

Of course, it is also possible to provide an active connection between the internal-combustion-engine clutch and the generator clutch to implement the functions described above.

Instead of or in addition to an active connection to the electric generator, an active connection to another machine unit, for instance a fan for cooling the internal combustion engine, can also be provided as an alternative or as an addition. This fan is only required in the internal-combustion-engine mode.

Depending on which machine unit is coupled to the drive train at the output end and which mode is selected, different active connections can be provided. In particular, it is conceivable that the electric motor clutch and the machine-unit clutch are operatively interconnected in such a way
that either the electric motor or the internal combustion engine and the at least one machine unit are jointly uncoupled from the drive train
or that the electric motor or the internal combustion engine and the at least one machine unit are jointly coupled to the drive train
or that the electric motor or the internal combustion engine is coupled to the drive train and the at least one machine unit is uncoupled from the drive train.

A particularly preferred embodiment of the disclosure can be such that the electric motor can be coupled to or uncoupled from a main shaft of the drive train by means of the electric-motor clutch, and in that a plurality of outputs are coupled to the main shaft at the output end. This makes it possible to design a transfer case that is easy to assemble having a minimum of parts and is characterized in particular by its reliable and robust design.

To reduce the design complexity, provision may be made for at least two output drives to be provided at the output end, each of which output drives drives at least one machine unit via a machine-unit clutch, and for the machine-unit clutches to be operatively interconnected in such a way that the two machine-unit clutches open or close conjointly, or that one machine-unit clutch opens and the other closes, wherein preferably provision is made for the two machine-unit clutches to be designed as claw clutches.

For instance, an electric generator can be coupled to an output via a generator clutch. A fan is coupled to the drive train via another output via a fan clutch. If the two machine units, i.e. the electric generator and the fan, are only required in the internal-combustion-engine mode, they can also be coupled to or uncoupled from the drive train conjointly. For this purpose, these two machine-unit clutches can be operatively interconnected, for instance mechanically or hydraulically. Nevertheless, the two machine-unit clutches can be individually designed to meet the requirements of the connected machine unit.

Additionally or alternatively, an output drive can also be provided at the output end, which output drive drives at least two machine units. Such a solution is particularly suitable if a clutch can be used that can be used for both connected machine units.

To simplify the shifting effort, provision may be made for the electric-motor clutch and/or for the internal-combustion-engine clutch to be held in a predetermined shift position in the open or in the closed clutch position, for the electric motor clutch and/or the internal-combustion-engine clutch to be moved from this predetermined shift position into the other shift position when a shift signal is applied, preferably against the pretension of a spring into the other shift position. This means that only one active shifting operation is required to shift this clutch from the first shift position to the second shift position. Shifting back from the second shift position to the first shift position then occurs automatically. For instance, this down-shifting process can then occur under the influence of a bias spring, which relaxes during the down-shifting process.

The shift signal for shifting the clutch can, for instance, be an electrical or a hydraulic shift signal. When this shift signal is applied, the internal-combustion-engine clutch and/or the electric-motor clutch can be moved from the first shift position to the second shift position. Preferably, shifting back occurs automatically when the shift signal is no longer present.

A particularly preferred variant of the disclosure can be designed such that the electric-motor clutch and/or the internal-combustion-engine clutch is/are designed as a hydraulically shiftable clutch, in particular as hydraulically shiftable claw clutch(es), and that the shift signal is formed by a hydraulic pressure, which is present in a hydraulic line connected to the electric motor clutch and/or to the internal-combustion-engine clutch.

If provision is made for a shift device to be connected to the electric motor clutch for moving the electric motor clutch between its shift positions, and that the shift device is operated by means of a power supply, then the electric motor clutch can only be shifted as intended when the power supply is connected. This prevents operating errors. In particular, a default operating position can be specified in that way, for instance the internal-combustion-engine mode. The system thus switches to internal-combustion-engine mode if no power supply is connected. If a power supply is connected, the electric-motor mode can also be activated.

The power supply can advantageously be an external power supply, which is also used to supply the electric motor with power in the electric-motor mode.

However, it is also conceivable that the internal power supply, i.e. the on-board power supply of the material processing system, is used.

To improve operational safety and to avoid operating errors, provision may be made for the internal-combustion-engine clutch and the electric-motor clutch to be operatively interconnected by means of a/the shift device such that, in an internal-combustion-engine mode, the shift device couples the internal combustion engine to the drive train by means of the internal-combustion-engine clutch and uncouples the electric motor from the drive train, and such that, in an electric-motor mode, the shift device uncouples the internal combustion engine from the drive train and couples the electric motor to the drive train by means of the electric-motor clutch.

In particular, provision may be made for the shift device to have a pressure generator, in particular a hydraulic pump, and for the electric motor clutch and the internal-combustion-engine clutch to be conjointly connected to the pressure generator, in particular via hydraulic lines. The hydraulic pump can be an electrically driven auxiliary hydraulic pump, for instance, which is preferably connected to the external power supply when the system is in electric-motor mode.

One possible variant of the disclosure can be such that at least one of the outputs has a speed conversion device by means of which the speed of the main shaft can be stepped up or down to an output speed that deviates from the speed of the main shaft. Additionally or alternatively, provision may be made for the internal combustion engine and/or the electric motor to be coupled to the main shaft by means of a speed adjustment device, and that preferably provision is made for the speed of the electric motor and/or of the internal combustion engine to be changed in the direction towards the main shaft by means of the speed adjustment device such that the main shaft is operated at the same speed in the internal-combustion-engine mode and in the electric-motor mode, or at the same speed with a range of fluctuation of ±10%, preferably 5%.

The speed adjustment device ensures that the main shaft is operated at the same or approximately the same speed in both modes, regardless of the selected drive type (combustion engine or electric-motor mode). Ideally, only the electric motor or only the internal combustion engine is connected to the main shaft by means of a speed adjustment device, which reduces efficiency and also the number of parts required.

### BRIEF DESCRIPTION OF THE DRAWINGS

The disclosure is explained in greater detail below based on an exemplary embodiment shown in the drawings. In the Figures:

FIG. 1 shows a side view of a schematic representation of a material processing plant 1 having a crusher unit 10, and

FIG. 2 shows a schematic block diagram of a material processing plant.

### DETAILED DESCRIPTION

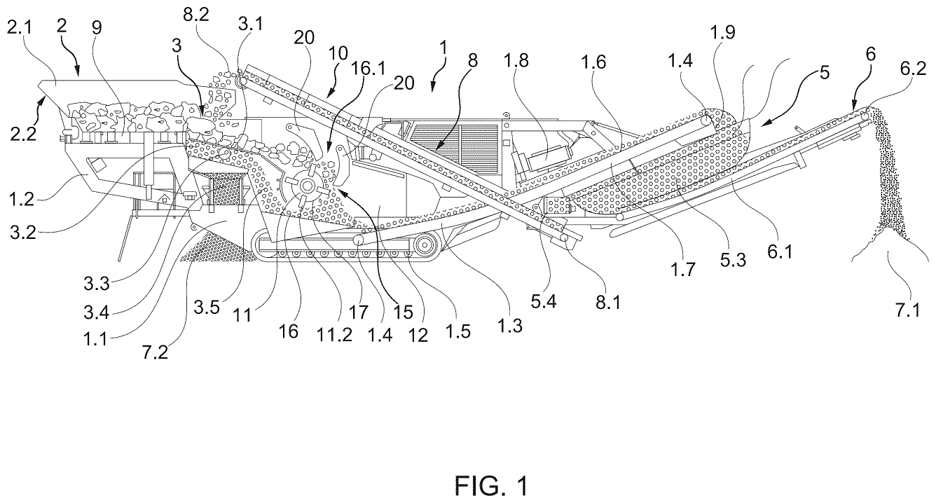

FIG. 1 shows a material processing plant 1 in the form of a crusher having a material processing unit in the form of a crusher unit 10. The material processing plant 1 is designed as a mobile material processing plant 1 and therefore has travel units 1.5. However, it is also conceivable that the material processing plant 1 is a stationary material processing plant 1.

The material processing plant 1 has a chassis 1.1 that bears the machine components or at least a part of the machine components. At its rear end, the chassis 1.1 can preferably have a cantilever 1.2. A material feed area is formed in the area of the cantilever 1.2.

The material feed area may comprise a feed hopper 2 and a material feed device 9.

The feed hopper 2 may be formed at least in part by hopper walls 2.1 extending in the direction of the longitudinal extent of the material processing plant 1 and a rear wall 2.2 extending transversely to the longitudinal extent. The feed hopper 2 leads to the material feed device 9.

As shown in this exemplary embodiment, the material feed device 9 comprise have a conveyor chute that can be driven by means of a vibratory drive. The feed hopper 2 can be used to feed material to be comminuted into the material processing plant 1, for instance using a wheel loader, and to feed it onto the conveyor chute.

From the conveyor chute, the material to be comminuted passes into the area of a screen unit 3. This screen unit 3 may also be referred to as a pre-screening arrangement. At least one screen deck 3.1, 3.2 is disposed in the area of the screen unit 3. In this exemplary embodiment two screen decks 3.1, 3.2 are used.

A partial fraction of the material to be comminuted is screened out at the upper screen deck 3.1. This partial fraction already has a sufficient particle size that it no longer needs to be comminuted in the material processing plant 1. In this respect, this screened out partial fraction can be routed past the crusher unit 10 through a bypass channel 3.5.

If a second screen deck 3.2 is used in the screen unit 3, a further fine particle fraction can be screened out from the partial fraction that accumulates below the screen deck 3.1. This fine particle fraction can be routed to a lateral discharge conveyor 3.4 below the screen deck 3.2. The fine particle fraction is diverted from the lateral discharge conveyor 3.4 and conveyed to a rock pile 7.2 located laterally of the machine.

As FIG. 1 illustrates, the screen unit 3 may be a vibrating screen having a screen drive 3.3. The screen drive 3.3 causes the screen deck 3.1 and/or the screen deck 3.2 to vibrate. Owing to the inclined arrangement of the screen decks 3.1, 3.2 and conjointly with the vibration motions, material on the screen decks 3.1, 3.2 is transported towards the crusher unit 10 or towards the bypass channel 3.5.

The material to be comminuted routed from the screen deck 3.1 is routed to the crusher unit 10, as shown in FIG. 1.

The crusher unit 10 may, for instance, take the form of a rotary impact crusher unit or a jaw crusher unit. If a rotary impact crusher unit is used, as in FIG. 1, it has, for instance, an impact rotor 11, which is driven by an internal combustion engine 12. In FIG. 1, the axis of rotation 17 of the impact rotor 11 is horizontal in the direction of the image depth. The impact rotor 11 is housed in a crushing chamber 16.1.

If a jaw crusher unit is used, two crushing jaws, which enclose a converging crushing shaft between them, which leads to a crushing gap, are positioned facing each other. At least one of the crushing jaws can be driven by the internal combustion engine 12 to crush the material to be crushed filled in the converging crushing gap.

For instance, the outer periphery of the impact rotor 11 may be equipped with impact bars 11.2. Opposite from the impact rotor 11, for instance, wall elements may be disposed, preferably in the form of impact rockers 20. When the impact rotor 11 is rotating, the impact bars 11.2 throw the material to be comminuted outwards. In so doing, this material hits the impact rockers 20 and is comminuted due to the high kinetic energy. When the material to be comminuted is of sufficient particle size to allow the material particles to pass through a crushing gap 15 between the impact rockers 20 and the radially outer ends of the impact bars 11.2, the comminuted material exits the crusher unit 10 through the crusher outlet 16.

It is conceivable that in the area of the crusher outlet 16, the comminuted material routed from the crusher unit 10 is combined with the material routed from the bypass channel 3.5 and transferred onto a belt conveyor 1.3. The belt conveyor 1.3 can be used to convey the material out of the working area of the crusher unit 10.

As shown in the drawings, the belt conveyor 1.3 may comprise an endless circulating conveyor belt having a slack side 1.6 and a tight side 1.7. The slack side 1.6 is used to catch and transport away the crushed material falling from the crusher outlet 16 of the crusher unit 10. At the belt ends, deflection rollers 1.4 can be used to deflect the conveyor belt from the slack side 1.6 to the tight side 1.7 and vice versa. Guides, in particular support rollers, can be provided in the area between the deflection rollers 1.4 to change the direction of conveyance of the conveyor belt, to shape the conveyor belt in a certain way and/or to support the conveyor belt.

The belt conveyor 1.3 has a belt drive, which can be used to drive the belt conveyor 1.3. The belt drive can preferably be disposed at the discharge end 1.9 or in the area of the discharge end 1.9 of the belt conveyor 1.3.

The belt conveyor 1.3 can be connected, for instance by means of the belt drive, to a control device by means of a control line.

One or more further belt conveyors 6 and/or a return conveyor 8 may be used, which in principle have the same design as the belt conveyor 1.3. In this respect, reference can be made to the above statements.

A magnet 1.8, in particular an electric magnet, can be disposed above the slack side 1.6 in the area between the feed end and the discharge end 1.9. The magnet 1.8 can be used to lift iron parts from the broken material and move them out of the conveying area of the belt conveyor 1.3.

A re-screening device 5 can be disposed downstream of the belt conveyor 1.3. The crusher unit 5 has a screen housing 5.1, in which at least one screen deck 5.2 is mounted. Below the screen deck 5.2, a housing base 5.3 is formed, which is used as a collection space for the material screened out at the screen deck 5.2.

An opening in the housing base 5.3 creates a spatial connection to the further belt conveyor 6. Here, the further belt conveyor 6 forms its feed area 6.1, wherein the screened material in the feed area 6.1 is directed onto the slack side of the further belt conveyor 6. The further belt conveyor 6 conveys the screened material towards its discharge end 6.2. From there, the screened material is transferred to a rock pile 7.1.

The material not screened out at the screen deck 5.2 of the re-screening device 5 is conveyed from the screen deck 5.2 onto a branch belt 5.4. The branch belt 5.4 can also be designed as a belt conveyor, i.e., reference can be made to the explanations given above with respect to the belt conveyor 1.3. In FIG. 1, the transport direction of the branch belt 5.4 extends in the direction of the image depth.

At its discharge end, the branch belt 5.4 transfers the un-screened material, also referred to as oversize material, to a feed area 8.1 of the return conveyor 8. The return conveyor 8, which may be a belt conveyor, conveys the oversize material towards the feed hopper 2. At its discharge end 8.2, the return conveyor 8 transfers the oversize material into the material flow, in particular into the material feed area. The oversize material can therefore be returned to the crusher unit 10 and crushed to the desired particle size.

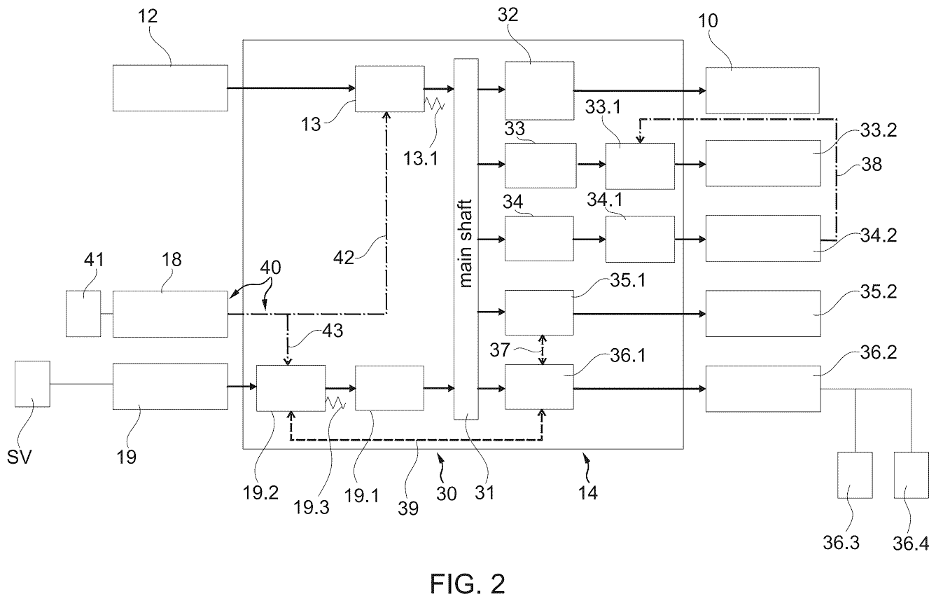

FIG. 2 shows a schematic block diagram of the material processing plant 1 according to FIG. 1. As this diagram illustrates, the material processing plant 1 has the internal combustion engine 12. An internal-combustion-engine clutch 13 can be used to couple the internal combustion engine 12 to a drive train 14 or uncouple it therefrom.

In addition, the material processing plant 1 also has an electric motor 19. An electric-motor clutch 19.2 can be used to either couple the electric motor 19 to the drive train 14 or uncouple it therefrom. The internal-combustion-engine clutch 13 and the electric-motor clutch 19.2 are designed as shiftable clutches, for instance as shiftable claw clutches. Preferably, these clutches can be hydraulically driven to move them between a closed and an open position.

The electric motor 19 can either be directly detachably connected to an external power supply SV or be indirectly detachably connected to the external power supply SV via the internal power supply 41 of the material processing plant 1.

It is possible that the internal-combustion-engine clutch 13 and the electric-motor clutch 19.2 are connected to a shift device 40 in such a way that they are operatively interconnected.

Preferably provision is made for the shift device 40 to have a hydraulic system having a pressure generator 18. The pressure generator 18 can be used to pressurize hydraulic fluid in the hydraulic system. The pressure generator 18 can be a hydraulic pump, for instance, which is supplied with power from the internal power supply 41. The internal power supply 41 can be the on-board power supply of the material processing system 1.

The pressure generator 18 is connected to the internal-combustion-engine clutch 13 and the electric-motor clutch 19.2 via hydraulic lines 42, 43, as shown by the dotted lines in FIG. 2. These two clutches 13 and 19.2 are hydraulically connected in parallel. However, it is also conceivable that the two clutches 13, 19.2 are operated sequentially. This can be done, for instance, upstream of the clutches 13, 19.2 to enable sequential shifting. This means that the pressure generator 18 can simultaneously operate the internal-combustion-engine clutch 13 and the electric-motor clutch 19.2.

The internal-combustion-engine clutch 13 can be a clutch that couples the internal combustion engine 12 to the drive train 14 in a first shifting state (closed position of the clutch) and uncouples it from the drive train 14 in a second shifting state (open position of the clutch).

Preferably, the internal-combustion-engine clutch 13 is brought into the second shifting state (internal combustion engine uncoupled) when a shifting pressure generated by the pressure generator 18 is present in the hydraulic line 42. If the pressure in the hydraulic line 42 drops to a pressure below the shifting pressure, the internal-combustion-engine clutch 13 automatically moves to the first shifting state. For instance, provision may be made for the internal-combustion-engine clutch 13 to be a spring-preloaded clutch that is moved against the preload of a spring 13.1 when changing from the first to the second shifting state. Preferably, the internal-combustion-engine clutch 13 thus automatically shifts to the first shifting state when the system is not connected to the external power supply (“e.g. onshore power supply”), such that the internal combustion engine is coupled to the mechanical drive train in “internal combustion mode”. Shifting to electric mode is only possible if an onshore power connection is available.

The electric-motor clutch 19.2 can be a clutch that couples the electric motor 19 to the drive train 14 in a first shifting state and uncouples it from the drive train 14 in a second shifting state.

Preferably, the electric-motor clutch 19.2 is brought into the first shifting state (electric motor coupled) when the shifting pressure generated by the pressure generator 18 is present in the hydraulic line 43. If the pressure in the hydraulic line 42 drops to a pressure below the shifting pressure, the electric-motor clutch 19 automatically moves to the second shifting state (electric motor uncoupled). For instance, provision may be made for the electric-motor clutch 19 to be a spring-preloaded clutch that is moved against the preload of a spring 19.3 when moving from the second to the first shifting state.

The aforementioned shifting pressure thus constitutes a shift signal by means of which the electric-motor clutch 19.1 and/or the internal-combustion-engine clutch 13 can be moved between their two shifting states.

FIG. 2 further illustrates that the electric motor 19 can be indirectly coupled to the drive train 14 via a speed adjustment device 19.1. Additionally or alternatively, provision may also be made for the internal combustion engine 12 to be coupled indirectly to the drive train 14 via a speed adjustment device not shown in FIG. 2. The speed adjustment device(s) 19.1 can be used to step up or step down the output speed of the internal combustion engine 12 or the electric motor 19. Preferably, the speeds of the internal combustion engine and the electric motor are the identical after they have been stepped up or stepped down.

FIG. 2 further illustrates that the drive train 14 may comprise a transfer case 30 having a main shaft 31. The internal combustion engine 12 and the electric motor 19 are coupled to this main shaft 31, as shown in FIG. 2.

At the output end, the main shaft 31 is coupled to at least one machine unit to mechanically drive the latter. For instance, it is conceivable that the crusher unit 10, at least one traction drive 33.2 of the travel unit 1.5, at least one hydraulic pump 34.2, at least one fan 35.2 for cooling the internal combustion engine 12 and/or at least one electric generator 36.2 could be used as a machine unit.

At least one of the machine units can be coupled, for instance directly, to the main shaft 31. Additionally or alternatively, it is also conceivable that at least one of the machine units is indirectly coupled to the main shaft 31 with the interposition of a clutch and/or a speed step-up or a speed step-down.

FIG. 2 illustrates that the crusher unit 10 is coupled to the main shaft 31, preferably via a shiftable crusher clutch 32. The crusher clutch 32 permits the crusher unit 10 to be either coupled to or uncoupled from the main shaft 31.

It is also conceivable that the crusher unit 10 is coupled to the main shaft 31 with the interposition of an intermediate speed step-up or a speed step-down. This can be an endless circulating belt drive, for instance, which is guided around two deflection rollers arranged spaced apart from each other. The deflection rollers have a different diameter to determine the step-up ratio or the step-down ratio.

FIG. 2 further illustrates that the traction drive 33.2 is indirectly coupled to the main shaft 31 with the interposition of a traction drive clutch 33.1 and a traction drive transmission 33. Additionally or alternatively, provision may also be made for the hydraulic pump 34.2 to be indirectly coupled to the main shaft 32 with the interposition of a hydraulic pump clutch 34.1 and a hydraulic pump transmission 34. It is conceivable that a rigid clutch instead of the hydraulic clutch 34.1 is provided between the hydraulic pump 34.2 and the main shaft 31. This is recommended if the hydraulic pump 34.2 is to be used both in the internal-combustion-engine mode and in the electric-motor mode.

Furthermore, FIG. 2 shows that the fan 35.2 is indirectly coupled to the main shaft 31 via a fan clutch 35.1 and the generator 36.2 is indirectly coupled to the main shaft via a generator clutch 36.1 and/or via a fan transmission or a generator transmission.

FIG. 2 shows that the electric-motor clutch 19.2 and the generator clutch 36.1 are intercoupled (coupling 39). The coupling 39 can preferably be a mechanical coupling 39 or a hydraulic coupling 39. In particular, the electric-motor clutch 19.2 and the generator clutch 36.1 can be combined to form a changeover clutch by means of the coupling 39.

The coupling 39 ensures that when the electric-motor clutch 19.2 is closed and the electric motor 19 is coupled to the main shaft 31, the generator clutch 36.1 is open and the generator 36.2 is uncoupled from the main shaft 31.

If the electric-motor clutch 19.2 switches over such that the electric motor 19.2 is uncoupled from the main shaft 31, the coupling 39 causes the generator clutch 36.1 to be closed and the generator 36.2 to be coupled to the main shaft 31.

In addition or alternatively, such a coupling 39 can also be provided between the electric-motor clutch 19.2 and the fan clutch 35.1 or another clutch at the output of the main shaft 31.

It is also conceivable that a coupling 39 can also be implemented indirectly. This is illustrated in FIG. 2. It is shown there that the fan clutch 35.1 and the generator clutch 36.1 are mechanically intercoupled via a coupling 37, such that these two clutches 35.1, 36.1 open or close conjointly. Of course, it is also conceivable that instead of the two clutches 35.1 or 36.1, only one clutch 35.1, 36.1 is used to (un)couple the fan 35.2 and the generator 36.2 to or from the main shaft 32.

Preferably provision is made for the electric-motor clutch 19.2 to be closed when the shift signal (for instance the shifting pressure in the hydraulic system (hydraulic lines 42, 43)) is applied to provide a coupling of the electric motor 19 to the main shaft 31. The coupling 39 then preferably causes another clutch to open (or close), in particular the generator clutch 36.1 and/or the fan clutch 35.1 is/are closed. If the shift signal is no longer present or if the shift signal is switched (change in hydraulic pressure), the electric-motor clutch 19.2 shifts to the open state and the electric motor 19 is uncoupled from the main shaft 31. The coupling 39 then causes the other clutch, in particular the generator clutch 36.1 and/or the fan clutch 35.1, to switch over. As FIG. 2 shows, these two clutches 36.1, 35.1 are then closed and the generator 36.2 and the fan 35.2 are coupled to the main shaft 31. In other words, when the electric motor 19 is uncoupled from the drive train, the generator and 36.2 and/or the fan 35.2 are engaged.

When the electric motor 19 is uncoupled, the internal combustion engine 12 is coupled and the system is in internal-combustion-engine mode.

In this exemplary embodiment, the pressure generator 18 is connected indirectly to the external power supply SV via the internal power supply 41.

However, it is conceivable and preferred that the pressure generator 18 is coupled to the external power supply SV, to which the electric motor 19 is also connected. This ensures that a change to the electric-motor mode can only be made if a connection to the external power supply SV has been established. If there is no connection to the external power supply SV, the system reverts to the internal-combustion-engine mode, preferably automatically.

The function of the material processing plant 1 shown in FIG. 2 is explained in more detail below. If the internal combustion engine 12 is coupled to the main shaft 31 via the internal-combustion-engine clutch 13 (internal-combustion-engine clutch 13 closed), the electric motor 19 is uncoupled from the main shaft 31 and the electric-motor clutch 19.2 is open. The material processing plant 1 is in the internal-combustion-engine mode.

In the internal-combustion-engine mode, the internal combustion engine 12 can drive at least some of the outputs via the main shaft 31 to supply the machine units with mechanical drive power. Then, the internal combustion engine 12, the crusher unit 10, the hydraulic pump 34.2, the fan 35.2 and the generator 36.2 can be driven.

If the material processing plant 1 is to be moved in travel mode, the traction drive 33.2 is activated. For this purpose, the traction drive clutch 33.1 can be closed. The internal combustion engine 12 then drives the traction drive 33.2.

As FIG. 2 illustrates, preferably the traction drive clutch 33.1 is may be hydraulic clutch. This traction drive clutch 33.1 can then be supplied with hydraulic fluid by the hydraulic pump 34.2 via a hydraulic line 38 to move it between its open and closed clutch positions.

Once the material processing system 1 has been moved to the desired position, the traction drive clutch 33.1 can be re-opened and the traction drive 33.2 can be uncoupled from the main shaft 31.

During the internal-combustion-engine mode, the generator 36.2 generates electricity while the generator clutch 36.1 is closed to supply electrical components or machine units of the material processing system 1.

For instance, the generator 36.2 can supply power to one or more electric motors. The electric motors can, for instance, be motors that drive at least one belt conveyor 1.3, the screen drive 3.3, the lateral discharge conveyor 3.4, the re-screening device 5, the branch belt 5.4, a further belt conveyor 6, the return conveyor 8 and/or the material feed device 9. It is also conceivable that the magnet 1.8 is designed as a solenoid and is supplied with power by the generator 36.2.

The hydraulic pump 34.2 can also be used to supply hydraulic components of the material processing plant 1 with hydraulic fluid. For instance, provision may also be made for at least one hydraulic motor and/or at least one hydraulic valve to be supplied with hydraulic fluid by means of the hydraulic pump 34.2.

If it is now necessary to switch from internal-combustion-engine mode to electric-motor mode, the internal combustion engine 12 is uncoupled from the main shaft 31 by means of the internal-combustion-engine clutch 13. The electric motor 19 is coupled to the main shaft 31 by means of the electric-motor clutch 19.2. For this purpose, provision may be made, for instance (as already explained above), for a hydraulic pressure to be built up in the hydraulic lines 42 and 43 using the pressure generator 18 as a shift signal. This hydraulic pressure causes a motion of the internal-combustion-engine clutch 13 and the electric-motor clutch 19.2.

This means that only the electric motor 19 is now coupled to the main shaft 31 at the drive end. The electric motor 19 now drives at least one of the aforementioned machine units via the main shaft 31, wherein this drive can be performed in the same way as in the internal-combustion-engine mode.

Therefore, only the changes that occur in the electric-motor mode have to be discussed below. For the rest, reference can be made to the above statements.

For instance, the coupling 39 between the electric-motor clutch 19.2 and the generator clutch 36.1 and/or the fan clutch 35.1 can now override the coupling of the generator 36.2 and/or the fan 35.2 to the main shaft 31. In fact, these components are not required during electric-motor mode and do not need to be dragged along. Provision may be made for the power supply of at least some of the machine components supplied by the generator 36.2 in the internal-combustion-engine mode to now be taken over by the external power supply SV, by means of which the electric motor 19 is also supplied with power.

The fan 35.2 for cooling the internal combustion engine 12 is also not required in the electric-motor mode and can therefore be uncoupled from the main shaft 31.

The pressure generator 18, which shifts the internal-combustion-engine clutch 13 and the electric-motor clutch 19.2, can be designed as a combination pump. This combination pump can have a second pump stage that is integrated into a cooling circuit. The cooling circuit can be used to supply a cooling circuit of the electric motor 19 with coolant. This provides cooling for the electric motor 19 in the electric-motor mode. Of course, it is also conceivable that these two functions could be separated. This means that two separate pump units can also be used, namely a first pump unit (pressure generator 18) to supply the clutches 13 and 19.2 and a second pump unit for the cooling circuit.

As mentioned above, the internal-combustion-engine clutch 13 and the electric-motor clutch 19.2 are preferably designed as claw clutches. For functional reasons, these clutches 13, 19.2 can only be engaged when stationary.

Now in an unfavorable position, the internal-combustion-engine clutch 13 and/or the electric-motor clutch 19.2 may not be able to be engaged. To nevertheless enable the engagement of the internal-combustion-engine clutch 13, provision may be made in the internal-combustion-engine mode, for the engine shaft of the internal combustion engine 12 to be rotated a little by means of the starter of the internal combustion engine 12 until the internal-combustion-engine clutch 13 is engaged. Additionally or alternatively, provision may also be made for the output shaft of the electric motor 19 to be rotated in the electric-motor mode to enable the engagement of the electric-motor clutch 19.2.

According to a variant of the disclosure, provision may be made, for instance, in the internal-combustion-engine mode, for an/the electric generator 36.2 to be driven by means of the drive train 14, for the electric generator 36.2 to supply at least one electric motor 36.3, 36.4 with current in the internal-combustion-engine mode, for the electric generator 36.2 to be separated from the drive train 14 by means of at least one generator clutch 36.1 in the electric-motor mode, and for the at least one electric motor 36.3, 36.4 to be supplied with current by a voltage supply SV in the electric-motor mode.

1-16. (canceled)

17. A drive for a material processing plant, comprising:
an internal combustion engine;
an electric motor;
a mechanical drive train having a drive end and an output end, the output end including at least one output;
an internal-combustion-engine clutch configured to selectively couple or uncouple the internal combustion engine with the mechanical drive train;
an electric-motor clutch configured to selectively couple or uncouple the electric motor with the mechanical drive train;
at least one machine unit driven by the at least one output;
at least one shiftable machine-unit clutch configured to couple or uncouple the at least one machine unit from the at least one output; and
a coupling operatively connecting the electric-motor clutch or the internal-combustion-engine clutch to the at least one machine-unit clutch.

18. The drive of claim 17, wherein:
the at least one machine unit includes an electric generator.

19. The drive of claim 17, wherein:
the coupling includes a mechanical coupling or a hydraulic coupling.

20. The drive of claim 17, wherein the coupling is configured such that the electric-motor clutch and the at least one machine-unit clutch are operatively interconnected such that:
the at least one machine unit and either the electric motor or the internal combustion engine are jointly uncoupled from the drive train; or
the at least one machine unit and either the electric motor or the internal combustion engine are jointly coupled to the drive train; or
the electric motor or the internal combustion engine is coupled to the drive train and the at least one machine unit is uncoupled from the drive train.

21. The drive of claim 17, wherein:
the mechanical drive train includes a main shaft;
the electric-motor clutch is configured such that the electric motor can be coupled to or uncoupled from the main shaft by the electric-motor clutch; and
the at least one output includes a plurality of outputs coupled to an output end of the main shaft.

22. The drive of claim 17, wherein:
the at least one output includes at least two outputs each of which drives at least one machine unit via a machine-unit clutch, wherein the machine-unit clutches are operatively interconnected such that the machine-unit clutches open conjointly or close conjointly, or such that one machine-unit clutch opens and the other machine-unit clutch closes.

23. The drive of claim 22, wherein:
the machine-unit clutches are claw clutches.

24. The drive of claim 17, further comprising:
an output drive connected to the output end of the mechanical drive train, the output drive driving at least two of the machine units.

25. The drive of claim 17, wherein:
the at least one machine-unit includes an electrical generator connected to at least one electrical load; or
the at least one machine-unit includes a fan for cooling the internal combustion engine.

26. The drive of claim 17, wherein:
the electric-motor clutch and/or the internal-combustion-engine clutch is held in a predetermined shift position in an open clutch position or in a closed clutch position; and
the electric-motor clutch and/or the internal-combustion-engine clutch is configured to be moved from the predetermined shift position to the other shift position when a shift signal is applied.

27. The drive of claim 26, wherein:
the electric-motor clutch and/or the internal-combustion-engine clutch includes a spring and the electric-motor clutch and/or the internal-combustion-engine clutch is moved against a pretension of the spring when the electric-motor clutch and/or the internal-combustion-engine clutch is moved from the predetermined shift position to the other shift position.

28. The drive of claim 27, wherein:
the electric-motor clutch and/or the internal-combustion-engine clutch is configured to automatically shift back from the other shift position to the predetermined shift position under action of the spring pretension when the shift signal is no longer applied or when a second shift signal is present at the electric-motor clutch and/or the internal-combustion-engine clutch.

29. The drive of claim 26, wherein:
the electric-motor clutch and/or the internal-combustion-engine clutch is a hydraulically shiftable clutch and the shift signal is formed by a hydraulic pressure in a hydraulic line connected to the electric-motor clutch and/or the internal-combustion-engine clutch.

30. The drive of claim 17, further comprising:
a shift device connected to the electric motor clutch and configured to move the electric motor clutch between an open position and a closed position; and
a voltage supply connected to the shift device to provide operating power to the shift device.

31. The drive of claim 30, wherein:
the voltage supply is an external voltage supply; and
the electric motor and the shift device are jointly connected to the external voltage supply in an electric-motor mode.

32. The drive of claim 17, further comprising:
a shift device operatively interconnecting the internal-combustion-engine clutch and the electric-motor clutch such that in an internal-combustion-engine mode the shift device uses the internal-combustion-engine clutch to couple the internal combustion engine to the drive train and decouples the electric motor from the drive train, and such that in an electric-motor mode the shift device decouples the internal combustion engine from the drive train and uses the electric-motor clutch to couple the electric motor to the drive train.

33. The drive of claim 32, wherein:
the shift device includes a pressure generator; and
the internal-combustion-engine clutch and the electric-motor clutch are connected conjointly to the pressure generator.

34. The drive of claim 17, wherein:
the mechanical drive train includes a main shaft; and
further including a speed adjustment device coupling the main shaft to the internal combustion engine or the electric motor, the speed adjustment device being configured such that an operating speed of the main shaft in an internal-combustion-engine mode is within a range of fluctuation of ±10% of the operating speed of the main shaft in an electric-motor mode.

35. The drive of claim 17, wherein:
the internal combustion engine includes an engine shaft and a starter and in an internal-combustion-engine mode the engine shaft of the internal combustion engine is rotatable by the starter to enable engagement of the internal-combustion-engine clutch; and/or
the electric motor includes an output shaft and in an electric-motor mode the output shaft is rotatable to enable engagement of the electric-motor clutch.

36. The drive of claim 17, wherein:
the internal-combustion-engine clutch and/or the electric-motor clutch is a spring-preloaded clutch which is moved against a preload of a spring when changing from a first shifting state to a second shifting state.
